(19) United States
(12) Patent Application Publication
(10) Pub. No.: US 2006/0182670 A1
(43) Pub. Date: Aug. 17, 2006

(54) Light-mediated air purification system and method

(76) Inventor: Susan Davis Allen, Jonesboro, AR (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 11/340,098

(22) Filed: Jan. 26, 2006

Related U.S. Application Data
(60) Provisional application No. 60/647,745, filed on Jan. 26, 2005.

(51) Int. Cl. B01J 19/12

(52) U.S. Cl. 422/186.3

(57) ABSTRACT

A system and method for cleaning air of harmful chemical and biological agents comprises a UV light source and photoactivatable catalyst impregnated in a porous material. Photoactivation of the catalyst generates hydroxyl radicals in the presence of water vapor, which destroy microbes and harmful chemicals. Representative devices include gas masks, respirators, and commercial air purification systems.

### REFERENCE TO RELATED APPLICATION

This application claims the benefit of U.S. Provisional Application No. 60/647,745, filed Jan. 26, 2005, the disclosure of which is incorporated herein by reference.

### FIELD OF THE INVENTION

The present invention relates to apparati and methods for purifying ambient air of harmful chemical and biological agents.

### BACKGROUND OF THE INVENTION

Air purification systems typically employ physical filters that serve as passive collection devices for dust particles, pollen, allergens, etc. For example, current gas masks use passive physical filters and adsorbents to remove potentially harmful biogens and toxic chemicals from the air before passing into a user's lungs. It would be advantageous, particularly whenever a user is in a setting that presents harmful biological and chemical agents, if removal of agents by filtration were accompanied by destruction, thereby preventing their subsequent inhalation, thus extending the life of the filtration device.

Multiple layer fabric composites have been developed for filtration devices. A representative material is composed of three layers: a top pre-filter layer, a middle adsorbent layer (which can contain activated carbon), and a next-to-skin layer. Such material was developed for use as protective clothing, but can also be used as a chemical decontamination wipe. It could also be used as an air filtration medium when provided with sufficiently numerous pores to permit airflow. Such a composite fabric material can effectively remove toxic chemicals and biogens. A preferred material is nonwoven and is provided with nanopores. However, any porous material would be effective. For example, both porous fabrics and foams could be used. Further, a series of porous layers with differing porosities could also be envisaged.

The use of nanopores enables the blockage of viruses as well as other biogens. Micropores would prevent passage of bacteria, molds and anthrax spores, but only a nanoporous material would prevent the passage of smaller viruses. In the preferred embodiment, these layers could be interconnected using advanced needle punching technology, which will fuse the layers without requiring adhesive or other similar interconnection methods. The porous material can be made with an electrospinning technique that generates nanoporous substrates from such materials as poly(ethylene oxide) (PEO), poly(acrylonitrile) (PAN), poly(vinyl alcohol) (PVA), poly(vinylidene fluoride), poly(trimethylene terephthalate), poly ethylene terephthalate (PET), polyurethane, poly(ε-caprolactone) poly(lactic acid), poly(glycolic acid) and their copolymers, and polyesters made from dicarboxylic acids and diols. The electrospun polymer fibers also reportedly can be impregnated or coated with catalysts. [See, e.g., Subbiah, T., et al., J. Appl. Polym. Sci., 2005, 96: 557-569; J. Deitzel, J. et al., Polymer, 2001, 42: 8163-8170; Qin, X., et al., Polymer, 2004, 45: 6409-13; Zhang, C., et al., Eur. Polym. J., 2005, 41: 423-432; Zhao, X., et al., J. Appl. Polym. Sci., 2005, 97: 466-474; Khil, M., et al., Polymer, 2004, 45: 295-301; Demir, M., et al, Polymer, 2002, 43: 3303-3309; Tan, E., et al., Biomaterials, 2005, 26: 1453-1456; Lee, K., et al., Polymer, 2003, 44: 1287-1294; Kim, K., et al., Biomaterials, 2003, 24: 4977-4985; Kenawy, E. et al., J. Contr. Rel., 2002, 81: 57-64; You, Y., et al, J. Appl, Polym. Sci., 2005, 95: 193-200; Kim, K., et al., J. Contr. Rel., 2004, 98: 47-56].

Separately, it has been reported that airborne microorganisms can be destroyed photochemically using titanium dioxide (TiO₂) powder deposited on a fiberglass filter in the presence of water vapor. Whenever the TiO₂ is exposed to an ultraviolet light source, e.g., emitting around 350 nm, such biogens as spores, bacteria, and viruses and toxic chemicals such as paints, solvents, pesticides, and other volatile organic compounds can be destroyed upon contact. This could also be used for the destruction of nerve agents, which can be neutralized by alkaline hydrolysis, such as with monoethanolamine for sarin and soman, or a mixture of ethylene glycol and ortho-phosphoric acid, e.g., for VX nerve agent (S-2-(di-isopropylamino)-ethyl O-ethyl methylphosphonothioate).

For instance, an air purification system employing this technology has been proposed for incorporation into the HVAC systems of buildings. [See, e.g., U.S. Pat. No. 5,933,702, issued to Goswami, D., et al.] Suitable doping of TiO₂ with transition metals may lead to photoactivation with lower energy, i.e., visible, light waves. Further chemical modification of the TiO₂ could produce a TiO₂ species that could be photactivated by visible light, such as sunlight and a larger spectrum of the light emitted from a fluorescent bulb. Also, altering of the catalyst used may lead to increased biocidal activity.

The mechanism of action of this method is believed to involve photoactivation of the solid catalyst to generate hydroxyl radicals in the presence of water vapor. This source of hydroxyl radicals then attacks and destroys microorganisms. Many other catalysts can also be used For example, semiconductor materials such as ZnO₂ and TiO₂ or similar materials could be used. Further, according to Goswami, any semiconductor material or a semiconductor in combination with a noble metal or other metal (such as silver) could be employed. [See, e.g., U.S. Pat. No. 5,933,702, issued to Goswami, D., et al.]

Depositing the TiO₂ on the surface of the material creates an unstable material. The catalyst is prone to flaking off of the material and would not be able to withstand washing of the material. Further, while TiO₂ is not a toxic material, the flaking off of the material could cause it to be inhaled into the lungs of a user, which is not desirable. Therefore, it would be preferable if the TiO₂ was fixed in the substrate through impregnation. This could be done in a number of ways. For example, the catalyst could be impregnated while melt-spinning the fibers to produce a doped fiber. Another method would be to shower the fiber with the catalyst while the fiber was still molten. Still another method could be to coat a fiber with the catalyst and run it through a heated region to anneal the catalyst to the fiber.

The preferred embodiment would be to impregnate the catalyst while melt-spinning the fibers. Nanopores are desired because they can block viruses. Thus it would not be efficient to create a porous material, then coat it with the catalyst, which would lead to the catalyst blocking the nanopores and effectively eliminating airflow. Goswami's material does not greatly limit air flow because his material is microporous rather than nanoporous. Therefore, deposition of the catalyst on the surface does not fully block the pores of his material.

The action of the photocatalytic layer could be supplemented by another layer, which is adsorbent. This layer could simply be a general adsorbent such as activated charcoal. Alternatively, this adsorbent layer could be an adsorbent specific to the compound which the user is trying to eliminate.

U.S. Pat. No. 6,681,765 (issued to Wen) proposes a gas mask that comprises a passive stage for filtration of airborne particles and an active stage for killing ambient bacteria and viruses. The active stage comprises a chemical agent effective in killing bacteria. The active stage reportedly may also comprise an apparatus for generating a magnetic or electric field, or a miniaturized UV light to help kill biological contaminants. Presumably, any ability of the UV light in killing the biological agents is by direct action, i.e., due to its known ability to cause genetic damage, thereby inhibiting growth and viability. Therefore, the length of time for destruction of the biological agent is sizable. The use of a photocatalytic element can decrease the time necessary for destruction of various microorganisms ten to twenty fold.

Another concern is the ability of the light to penetrate the material and activate the catalyst. If the porous layer used is thick, the light will only penetrate a shallow distance into the material. Therefore, it is desirable to develop a compact porous material, especially for use in a small, portable device such as a gas mask. In a larger system, such as a building air purification system, an array of porous layers could be used of varying porosities and each with their own light array to activate the catalyst. For example, air could flow through a series of porous materials which would sequentially filter smaller items out of the air (i.e. spores, then bacteria, then viruses, then molecules).

It is desired to develop a compact air purification device for use as a gas mask, respirator, or air cleaner, such as for homes and offices. Such device should permit passage of sufficient airflow to provide adequate air supplies. However, it should also afford destruction of harmful microbes and chemical agents, in addition to filtering them from the air.

### SUMMARY OF THE INVENTION

The present invention is a method and system for purifying air of microbes and harmful chemicals. The purification system can be in the form of a personal gas mask, a respirator, or an air cleaning system for the office, factory or home. Common to each application is a porous material that is impregnated with a photoactivatable catalyst, such as titanium dioxide. When ultraviolet light is directed onto a surface of the porous material, the catalyst is activated and is effective in destroying microbes and/or chemicals that come in contact with it. Without wishing to be bound by any particular theory, it is believed that the catalyst works by generating active hydroxyl radicals in the presence of water vapor.

### BRIEF DESCRIPTION OF THE DRAWINGS

FIG. 1 depicts a preferred embodiment of a gas mask according to principles of the present invention.

FIG. 2 depicts a preferred embodiment of an air cleaner according to principles of the present invention.

### DETAILED DESCRIPTION OF THE INVENTION

The present invention is a light-mediated air purification system that can be employed in a personal respirator or gas mask, or in a commercial air cleaner such as for the home or office. The air purification system is effective in killing microbes and/or neutralizing harmful chemical agents, by employing UV light to activate a catalyst-coated or impregnated porous material such as a fabric or foam. It is believed that in the presence of water vapor, the activated catalyst generates hydroxyl radicals, which attack biological agents and react with organic compounds. By killing airborne microbes and altering the structures of chemical agents, ambient air can be purified of these agents.

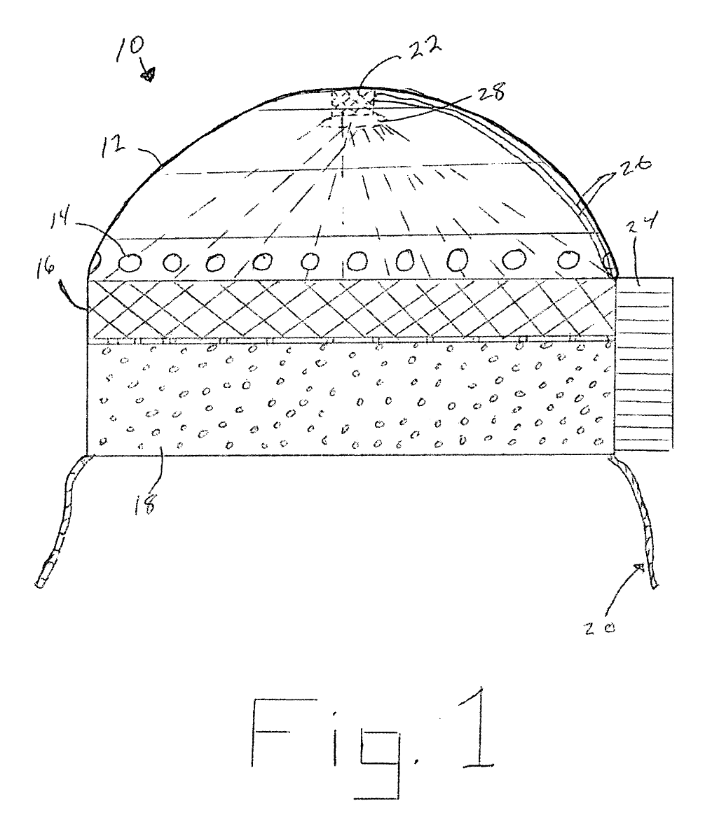

As shown in FIG. 1, a preferred embodiment of the present invention is gas mask 10. The gas mask comprises thermoplastic housing 12, which is provided with a plurality of inlet ports 14 through which ambient air can pass when a wearer inhales. Air passing through the inlet ports goes through porous material 16, which supports a photoactivatable catalyst material, before passing through a bed of activated charcoal 18. The relative humidity of the air at the reaction site (porous material 16) can be adjusted by the wearer so as to optimize performance by opening/closing the inlet ports. The mask is attached to the user with flexible air-tight fittings 20. UV light source 22 is attached to the inner wall of housing 12 and shines onto porous material 16. The light source is powered by battery 24, which is in electrical communication with the light source via leads 26. Dispersing means 28 is optionally used to disperse the light from the light source so that the light is well-distributed onto the porous material.

One or more commercially available UV light emitting diodes (LEDs), such as those available from Roithner Lasertechnik, Inc. (Vienna, Austria), can be employed as light source 22. LEDs emitting at 350 nm are considered ideal for exciting TiO₂ and producing the microbe-destroying hydroxyl radicals. UV diode lasers or other high efficiency, high brightness, compact light sources may also be employed.

Means for dispersing light 28 that can be used with the invention include a lens, waveguide, fiber array, diffusing mirror, holographic optical element (HOE), diffractive optical element, and others, as apparent to the skilled practitioner.

An aforementioned porous material can comprise any material that is both porous and effective in supporting the photoactivatable catalyst. Preferred materials are those that can be provided with micropores or nanopores. Such materials can be electrospun into nanofibers. Layers of these materials can then be needlepunched to bind them together. Preferred materials include those comprising polymer fibers of poly(ethylene oxide) (PEO), poly(acrylonitrile) (PAN), poly(vinyl alcohol) (PVA), poly(vinylidene fluoride), poly ethylene terephthalate (PET), poly(trimethylene terephthalate), polyurethane, poly(E-caprolactone) poly(lactic acid), poly(glycolic acid) and their copolymers, and polyesters made from dicarboxylic acids and diols.

Also contemplated is an air cleaning device for use in the home, factory or office. Such a device comprises a housing that is provided with inlet and exit openings to permit the passage of air therethrough. A porous material is provided internal the housing and the porous material supports a photoactivatable catalyst that is effective in destroying microbes and toxic chemicals. A means for passing air through the porous material, such as a fan, is also provided. A UV light source is provided interior the housing so that light emitted from the light source impinges on the porous material and photoactivates the catalyst sufficiently to destroy any microbes, including mold and mold spores, and toxic chemicals that come in contact with it.

A UV light source employed with the air cleaning device can comprise one or more light emitting diodes, lasers, or lamps. A light dispersing means can also be provided adjacent the UV light source to ensure coverage of the porous material bearing the photoactivatable catalyst.

An air cleaning device can also comprise an adsorbent material supported within the housing, such as activated charcoal, in order to provide additional cleansing of the air. Charcoal would be a general adsorbent that could be used. A specific adsorbent could also be used in a system where elimination of a specific toxic agent is desired. Also, a relative humidity sensor can be provided within the housing to ensure that adequate water vapor is available to maintain activity of the catalyst. Normal breathing should provide adequate moisture to activate the catalyst in a gas mask system. External humidity systems may be required for building air purification systems.

A device of the present invention can be employed in the destruction and/or removal of bioaerosols, such as bacteria, viruses, fungi, spores, mildew, dust mites, pet dander, and the like. It can be used either alone or in conjunction with a size-exclusion filter effective in removal of airborne particulates, e.g., for removal of particles down to 1 micron in size, and/or with a substance effective in removing volatile organic compounds, such as activated charcoal. Whenever a porous material of the present invention is doped with TiO₂ or other suitable catalyst and is provided with micropores or nanopores, it can be employed both to remove bioaerosols from ambient air, as well as to destroy living materials deposited on the material. Allergies, asthma, and other respiratory conditions can thereby be alleviated.

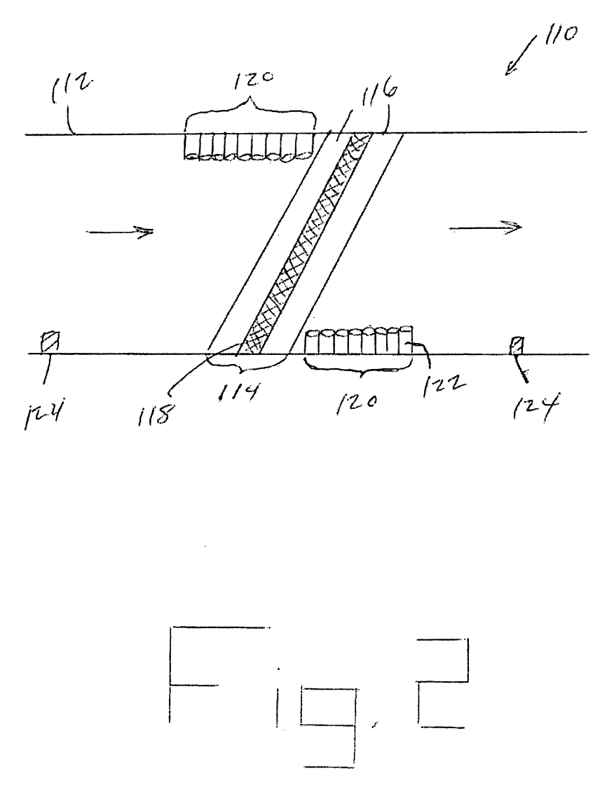

As shown in FIG. 2, a preferred air cleaner 110 comprises housing 112 through which an air stream is passed, e.g., by an external fan. Air passes through filtration device 114, which comprises titanium dioxide-doped porous materials 116. Within the porous materials is contained activated charcoal 118 for adsorbing any chemical vapors. Light arrays 120 comprised of a plurality of UV light sources 122 are positioned internal the housing and directed onto the porous material. The light sources are preferably UV lamps, lasers, or LEDs and can be fitted with optics as necessary to ensure adequate light coverage of the porous material. For such larger devices as air cleaners, nitrogen lasers operating at 337 nm (Laser Science, Inc.) can be employed. Other lasers operating at 355 nm (Nd:YAG), 351 nm, and 308 nm (excimer lasers) can also be used. The light sources can be powered by a battery or more typically with an external alternating current source (not shown).

Relative humidity sensors 124 positioned internal the housing and on opposing sides of the air filtration device can be used to monitor the humidity of the air, such as in an air conditioning unit. Optionally, separate means for controlling the relative humidity in the air stream can be provided if necessary. [See, e.g., U.S. Pat. No. 5,933,702, issued to Goswami].

The present invention has been described hereinabove with reference to particular examples for purposes of clarity and understanding rather than by way of limitation. It should be appreciated that certain improvements and modifications can be practiced within the scope of the appended claims and equivalents thereof.

What is claimed is:

1. An air purification system effective in destroying microorganisms and toxic chemicals, comprising:
(i) a housing provided with at least one opening, which permits passage of air therethrough;
(ii) a porous material provided internal the housing, which porous material is impregnated with a photoactivatable catalyst effective in destroying microbes and toxic chemicals; and
(iii) a UV light source provided interior the housing and promixal the porous material, so that light emitted from the light source impinges on the material and photoactivates the catalyst sufficiently to destroy microbes and toxic chemicals in contact therewith.

2. The air purification system of claim 1, wherein the porous material is nanoporous.

3. The air purification system of claim 1, wherein the porous material comprises electrospun polymer fibers.

4. The air purification system of claim 1, wherein the porous material comprises:
i. a first porous layer and a second porous layer; and
ii. an adsorbent layer between said first porous layer and said second porous layer.

5. The air purification system of claim 1, wherein the catalyst comprises TiO₂.

6. The air purification system of claim 1, wherein hydroxyl radicals are generated by the photoactivated catalyst.

7. The air purification system of claim 1, wherein the UV light source comprises at least one light emitting diode.

8. The air purification system of claim 1, wherein a light dispersing means is provided adjacent the UV light source.

9. The air purification system of claim 2, wherein the porous material comprises electrospun polymer fibers.

10. The air purification system of claim 2, wherein the porous material comprises:
i. a first porous layer and a second porous layer; and
ii. an adsorbent layer between said first porous layer and said second porous layer.

11. The air purification system of claim 2, wherein the catalyst comprises TiO₂.

12. The air purification system of claim 2, wherein hydroxyl radicals are generated by the photoactivated catalyst.

13. The air purification system of claim 2, wherein the UV light source comprises at least one light emitting diode.

14. The air purification system of claim 2, wherein a light dispersing means is provided adjacent the UV light source.

15. The air purification system of claim 1 in the form of a personal gas mask, wherein:
(i) the housing is provided with a plurality of holes permitting passage of air therethrough;
(ii) flexible attachment means are joined to the housing, which can be used to attach to a user's face; and
(iii) a battery is provided, wherein the UV light source is in electrical communication with the battery.

16. The device of claim 15, wherein the porous material is nanoporous.

17. The device of claim 15, wherein the porous material comprises electrospun polymer fibers.

18. The device of claim 15, wherein the catalyst comprises TiO₂.

19. The device of claim 15, wherein hydroxyl radicals are generated by the photoactivated catalyst.

20. The device of claim 15, wherein the UV light source comprises at least one light emitting diode.

21. The device of claim 15, wherein a light dispersing means is provided adjacent the UV light source.

22. The device of claim 15, further comprising a relative humidity sensor within the housing.

23. The device of claim 15, further comprising a compartment containing an adsorbent material which is provided adjacent the porous material and opposing the plurality of holes;

24. The air purification system of claim 1 in the form of a building air purification system, wherein:
(i) the housing is provided with inlet and exit openings that permit passage of air therethrough; and
(ii) fan means is provided interior the housing for passing air through the porous material.

25. The device of claim 24, wherein the porous material comprises electrospun polymer fibers.

26. The device of claim 24, wherein the catalyst comprises TiO₂.

27. The device of claim 24 wherein hydroxyl radicals are generated by the photoactivated catalyst.

28. The device of claim 24, wherein the UV light source comprises at least one light emitting diode.

29. The device of claim 24, wherein a light dispersing means is provided adjacent the UV light source.

30. The device of claim 24, wherein the porous material comprises:
i. A first porous layer and a second porous layer;
ii. and an adsorbent layer between said first porous layer and said second porous layer.

31. The device of claim 24, further comprising a relative humidity sensor within the housing.

32. A method of destroying airborne microbes and toxic chemicals, comprising:
(i) providing the air purification system of claim 1;
(ii) activating the photoactivatable catalyst, which is supported on the porous material provided within the housing, with UV light; and
(iii) contacting the airborne microbes and toxic chemicals with the photoactivated catalyst.

33. The method of claim 32, wherein the porous material comprises electrospun polymer fibers.

34. The method of claim 32, wherein the catalyst comprises TiO₂.
